(19) United States
(12) Patent Application Publication
(10) Pub. No.: US 2026/0301292 A1
(43) Pub. Date: Oct. 1, 2026

(54) CIRCUITRY, METHOD AND SYSTEM

(71) Applicant: Sony Group Corporation, Tokyo (JP)

(72) Inventors: Nabil LOGHIN, Tokyo (JP); Justinas MISEIKIS, Tokyo (JP)

(73) Assignee: Sony Group Corporation, Tokyo (JP)

(21) Appl. No.: 19/565,555

(22) Filed: Mar. 13, 2026

(30) Foreign Application Priority Data
Mar. 25, 2025 (EP) 25165971.0

(51) Int. Cl. G06T 13/40; G11B 27/036

(52) U.S. Cl. CPC G06T 13/40; G11B 27/036

(57) ABSTRACT

The disclosure pertains to circuitry that is configured to obtain input video data and associated metadata, wherein the input video data represent a video sequence, and wherein the metadata indicate a consistency constraint for modifying a feature of the video sequence; cause a generative artificial intelligence model to generate a modification of the feature in accordance with the consistency constraint; and generate output video data that represent the video sequence in which the feature is replaced by the modification of the feature.

### CROSS-REFERENCE TO RELATED APPLICATION

This application is based upon and claims the benefit of priority from the prior European Patent Application No. 25165971.0 filed on Mar. 25, 2025, the entire contents of which are incorporated herein by reference.

### TECHNICAL FIELD

The present disclosure generally pertains to circuitry, a method and a system.

### TECHNICAL BACKGROUND

Technologies that are related to artificial intelligence (AI), including generative AI and deep fake technologies, are generally known. For example, generative AI may generate video data that represent a movie based on a written description of a content of the movie and/or based on an input image.

Although there exist techniques for video generation based on AI, it is generally desirable to provide improved circuitry, an improved method and an improved system.

### SUMMARY

According to a first aspect, the disclosure provides circuitry that is configured to:
obtain input video data and associated metadata,
   wherein the input video data represent a video sequence, and
   wherein the metadata indicate a consistency constraint for modifying a feature of the video sequence;
cause a generative artificial intelligence model to generate a modification of the feature in accordance with the consistency constraint; and
generate output video data that represent the video sequence in which the feature is replaced by the modification of the feature.

According to a second aspect, the disclosure provides a method that includes:
obtaining input video data and associated metadata,
   wherein the input video data represent a video sequence, and
   wherein the metadata indicate a consistency constraint for modifying a feature of the video sequence;
causing a generative artificial intelligence model to generate a modification of the feature in accordance with the consistency constraint; and
generating output video data that represent the video sequence in which the feature is replaced by the modification of the feature.

According to a third aspect, the disclosure provides a system that includes:
circuitry in accordance with the first aspect; and
a streaming server that is configured to:
   indicate, to a user, a predetermined set of modifications of the feature;
   receive, from the user, a request for a selected modification of the set of modifications;
   obtain, from the circuitry, the output video data, wherein the output video data represent the video sequence in which the feature is replaced by the selected modification; and
   stream the output video data to the user.

According to a fourth aspect, the disclosure provides a system that includes:
circuitry in accordance with the first aspect;
first glasses with a first transmission characteristic;
second glasses with a second transmission characteristic different from the first transmission characteristic; and
a display portion that is configured to:
   obtain, from the circuitry, first output video data and second output video data,
      wherein the first output video data represent the video sequence in which the feature is replaced by the modification, and
      wherein the second output video data represent the video sequence in which the feature is not replaced by the modification;
   output a first display according to the first output video data at a first output characteristic that corresponds to the first transmission characteristic, such that the first display is transmitted by the first glasses and blocked by the second glasses; and
   output a second display according to the second output video data at a second output characteristic that corresponds to the second transmission characteristic, such that the second display is transmitted by the second glasses and blocked by the first glasses.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 illustrates an embodiment of circuitry;

FIG. 2 illustrates an embodiment of a method;

FIG. 3 illustrates examples of modifications of a feature according to an embodiment;

FIG. 4 illustrates a first embodiment of a system;

FIG. 5 illustrates a second embodiment of a system;

FIG. 6 illustrates a first embodiment of outputting a first display and a second display;

FIG. 7 illustrates a second embodiment of outputting a first display and a second display; and

FIG. 8 illustrates an embodiment of a general-purpose computer.

### DETAILED DESCRIPTION OF EMBODIMENTS

Before a detailed description of the embodiments under reference of FIG. 1 is given, general explanations are made.

As mentioned in the outset, technologies that are related to artificial intelligence (AI), including generative AI and Deep Fake technologies, are generally known. For example, generative AI may generate video data that represent a movie based on a written description of a content of the movie and/or based on an input image and/or based on a video sequence of another style.

For example, in some instances, it is possible to digitally replace a person or certain features such as tattoos within a short video sequence and/or within an image (e.g., face swapping).

It has been recognized, however, that generative AI may offer more opportunities for full movies. For example, so far, localization of a movie (e.g., adopting the movie to regional requirements) is limited in some instances to voice dubbing for translation and/or subtitles.

Consequently, some embodiments pertain to circuitry that is configured to:
obtain input video data and associated metadata,
   wherein the input video data represent a video sequence, and
   wherein the metadata indicate a consistency constraint for modifying a feature of the video sequence;
cause a generative artificial intelligence (AI) model to generate a modification of the feature in accordance with the consistency constraint; and
generate output video data that represent the video sequence in which the feature is replaced by the modification of the feature.

The circuitry may include a processing portion (e.g., a microprocessor, an application-specific integrated circuit (ASIC), a field-programmable gate array (FPGA), a central processing unit (CPU), a graphics processing unit (GPU), a tensor processing unit (TPU), or any other suitable device) that is configured to execute software and/or firmware instructions, a storage portion (e.g., based on flash memory (e.g. a solid-state disk (SSD)), magnetic memory (e.g., a hard-disk drive (HDD)), optical memory, dynamic random-access memory (DRAM), synchronous dynamic random-access memory (SDRAM), or the like) that is configured to store data used and/or generated by the processing portion, and a communication portion (based on, e.g., Peripheral Component Interconnect (PCI), Universal Storage Bus (USB), Ethernet, InfiniBand, wireless local area network (WLAN; e.g., the IEEE 802.11 family (Wi-Fi)), or the like) that is configured to receive data (e.g., the input video data) and to transmit data (e.g., the output video data). The circuitry may be configured as a general-purpose computer as described with respect to FIG. 8.

The input video data may be formatted according to any suitable video codec, e.g., MPEG-1, MPEG-2, MPEG-4, H.262, H.263, H.264, H.265, VP6, VP7, VP8, VP9, HDCAM, Theora, etc. The video sequence may include a plurality of frames, e.g., a sequence of single image frames, key frames, interframes, inbetweens, etc. The video sequence may represent any content that may be suitably represented as a video sequence. For example, the video sequence may represent a movie, a series, a TV show, a sports match, footage of a historical event, a commercial, a music video, an educational video, a game (e.g., computer game, video game, smartphone game, online game, etc.), or the like.

The metadata may be included in the input video data, or the circuitry may receive the metadata separately, e.g., in a separate file, in a separate stream and/or in a separate data medium. The consistency constraint may indicate which feature of the video sequence may be modified, how the feature may be modified and/or which aspect of the feature should be preserved in the modification. The consistency constraint may also indicate a feature of the video sequence that should not be modified, e.g., because a meaning and/or story of the video sequence may be based on the feature, because modifying the feature may be reserved to a predetermined permission (e.g., based on a license and/or payment plan), and/or because an author of the video sequence may protect the video sequence from disfigurement. The metadata may be configured as text (e.g., in natural language and/or in a structured format such as Extensible Markup Language (XML), JavaScript Object Notation (JSON), or the like), a three-dimensional file format (e.g., based on Pixar's Universal Scene Description (USD), Blender “blend” file format, OBJ format, FBX format, GL Transmission Format (glTF), or the like), an audio message, an image mask (e.g., for masking features of the video sequence that may or may not be modified), a label (e.g., for identifying the feature), an embedding for the generative AI model, etc.

The generative AI model may be configured to receive the input video data (or at least a portion of the input video data that includes the feature), the metadata (or at least a portion of the metadata that corresponds to the consistency constraint for modifying the feature) and a modification instruction. The modification instruction may include a text message (e.g., in natural language and/or in a structured format such as XML, JSON, or the like) that describes the desired modification, an audio message that describes the desired modification, an image that corresponds to the desired modification (e.g., an image to be inserted into the video sequence), an identifier (e.g., number, code, name, keyword, etc.) that indicates a modification of a set of predefined modifications, an embedding that indicates the modification, a segmentation mask that indicates an area in the video sequence (e.g., a set of pixels) in which the feature may be replaced (e.g., based on inpainting), or the like. However, the generative AI model may also be configured to generate a modification without receiving a modification instruction. For example, the generative AI model may be configured to generate a predetermined modification for any input video data, and/or the generative AI model may be configured to determine a modification by itself.

The generative AI model may be configured to generate the modification of the feature according to the modification instruction within the consistency constraint indicated by the metadata, and to output the modification. For example, the generative AI model may generate a video sequence that includes the modification instead of the feature.

The generative AI model may be based on and/or may include an artificial neural network (NN) such as a feedforward NN (FNN), a convolutional NN (CNN), a recurrent NN (RNN), a long short-term memory (LSTM), a gated recurrent unit (GRU), a radial basis function NN (RBFNN), a variational autoencoder (VAE), a generative adversarial network (GAN), a self-organizing map (SOM), a transformer network, a spiking neural network (SNN), a vision transformer model (ViT), a diffusion model, or any other suitable type of generative AI model. For example, the generative AI model may include and/or may be configured similar to Sora, Veo, DALL-E, Imagen, Midjourney, Stable Diffusion, etc.

The generative AI (GenAI) model may be an AI that has learned from a huge amount of data, e.g., in unsupervised manner, and that may be able to re-create similar content that is similar to at least a portion of the learned data (e.g., by combining, mixing and/or merging learned data, and/or by interpolating between learned data). The generative AI model may even learn from one media type (e.g., text) and then generate content in another media type, such as 3D objects or images. The generative AI model may apply some transformer, which may translate training data to a latent space, in which the training data may have a different representation (e.g., as an embedding).

The generative AI model may be trained based on a training dataset that may include a variety of video data, associated metadata, and, in some embodiments, modification instructions. For the training, the generative AI model may receive video data, associated metadata and, potentially, a modification instruction from the training dataset and may generate a modification according to parameters (e.g., network weights) of the generative AI model. The generated modification may be evaluated (e.g., by a user and/or by an AI model) based on determining a degree of accordance of the generated modification with the consistency constraint and, if provided, with the modification instruction, and/or by determining a difference between the generated modification and a predetermined modification. Based on a result of the evaluating, parameters of the generative AI model may be adjusted for increasing the degree of accordance and/or reducing the difference, e.g., based on a gradient in a loss function, cost function, error function or the like. The training may be performed based on various video data, associated metadata and, possibly, modification instructions of the training dataset until the training converges (e.g., until adjusting the parameters does not improve an output of the generative AI model any more or until an improvement of the output is less than a predetermined threshold).

The circuitry may generate the output video data by replacing the feature with the generated modification, e.g., by overwriting the feature in the input video data with the modification, or by deleting the feature and then inserting the modification. For example, in a case where the circuitry inputs the whole video sequence of the input video data into the generative AI model, the circuitry may insert a video sequence generated by the generative AI model without further modification into the output video data instead of the video sequence of the input video data. The circuitry may further adapt metadata (e.g., video duration, video resolution, video codec, etc.) of the output video data.

In some embodiments, the consistency constraint indicates a criterion for the modification of the feature for maintaining a consistency of the modification with the video sequence.

The criterion for the modification may indicate a condition under which the modification integrates into the video sequence. The consistency constraint may indicate a visual criterion that may pertain to a visual integration of the modification into the video sequence, e.g., a position, size, color, lighting or the like. The consistency constraint may indicate a semantic criterion that may pertain to a property of the feature that may be required by a storyline of the video sequence, e.g., a scar in a face of a character, a Facial Action Coding System (FACS), describing facial movements and appearances, a human pose modelling, e.g., according to Skinned Multi-Person Linear model (SMPL), a certain license number of a car, etc.

If the modification of the feature violates the consistency constraint (e.g., does not fulfill the criterion), the modification may feel unnatural or inconsistent to a user who is watching the video sequence, for example, the user may notice that a feature of the video sequency has been modified and/or that the storyline of the video sequence is not logical.

The generative AI model may be configured (e.g., trained) to generate the modification such that it fulfills the criterion indicated by the consistency constraint. The circuitry (e.g., the generative AI model and/or another function (e.g., another AI model)) may determine whether the generated modification fulfills the criterion. If the generated modification fulfills the criterion, the circuitry may generate the output video data with the modification. Otherwise, the circuitry may cause the generative AI model to generate a further modification, e.g., based on another seed, on adapted temperature settings, on an adapted modification instruction, or the like.

In some embodiments, the consistency constraint indicates a lighting condition of the feature.

For example, the consistency constraint may indicate a position, brightness, light temperature, color, shape, size or the like of a light source, a shadow and/or a position, shape, size, opacity etc. of a shadow-casting object. Thus, based on the consistency constraint, the generative AI model may generate the modification with a brightness, color, shadow (e.g., cast shadow and/or form shadow), flare, etc. that may be consistent with another portion of the video sequence.

In some embodiments, the consistency constraint indicates a relation between the feature and another feature of the video sequence.

The relation may be a geometric relation. For example, the consistency constraint may indicate that a position, orientation, size, shape or the like of the modification should correspond to a position, orientation, size, shape or the like of the feature with respect to the other feature.

For example, the metadata may indicate a position, orientation, size, shape or the like of the other object, and/or the metadata may indicate an identifier the other object (e.g., a label, a position, a mask or the like) such that the generative AI model may recognize the other object in the video sequence based on the identifier. For example, the metadata may indicate depth information of the video sequence (or at least of the other object), video layers (e.g., bluescreen or greenscreen for chroma keying, virtual background, etc.) of the video sequence, or any other information that may indicate a three-dimensional structure of a scene represented by the video sequence.

The relation may be a semantic relation. For example, the consistency constraint may indicate a corporate clothing of characters in the video sequence that are members of a same organization. For example, the consistency constraint may indicate a parent-child relationship between a character that corresponds to the feature and another character that corresponds to the other feature such that the generative AI model may generate the modification such that similarities (e.g., hair color, eye color, skin color, birthmark, etc.) between the modification and the other feature according to the parent-child relationship are maintained, e.g., by generating the modification based on the other feature and/or by modifying the other feature accordingly.

The skilled person may find further relations between the feature and the other feature that may be indicated by the consistency constraint.

In some embodiments, the consistency constraint indicates an identity of the feature with another feature of the video sequence.

The metadata may indicate an identifier, a label, a mask or the like, based on which the generative AI model may determine that the feature is identical to the other feature.

For example, the consistency constraint may indicate that a character that is represented by the feature is a same character that is represented by the other feature. For example, the character may appear in different scenes in the video sequence (e.g., may disappear and re-appear), and the consistency constraint may indicate that, when modifying the character in one scene, the character should be modified correspondingly in the other scenes as well.

In some embodiments, the feature includes movable portions; and the consistency constraint indicates a position of the movable portions in the video sequence.

Thus, a probability that the generative AI model generates unnatural movements may be reduced by the consistency constraint.

For example, if the feature represents a character (e.g., a human being, an animal, a robot, etc.) of the video sequence, the consistency constraint may indicate a position and/or an orientation of limbs, bones and/or of joints of the character such that the generative AI model may generate the modification such that a movement of a character represented by the modification corresponds to a movement of the character represented by the feature.

In some embodiments, the feature includes a representation of a drive actor; and the metadata include a position marker in the representation of the drive actor.

The drive actor may be an actor who performs a movement of the character as a template for the modification. The position marker may correspond to a key point of the movement of the drive actor.

The position marker may be attached to the drive actor before capturing a video of the drive actor such that the video shows the position marker. The position marker may correspond to a bead, a ball, a sign, a sticker, a drawing, a symbol or the like and may be configured to be easily detectable by an image processing program (e.g., based on a high contrast, a predetermined color, a predetermined pattern, or the like). The drive actor may wear a plurality of markers, e.g., at limbs, at joints, at his face, etc. The position markers in the video sequence may indicate, as the metadata, a movement of the drive actor.

Alternatively, the video of the drive actor may be captured without physical position markers. For example, a movement of the drive actor may be tracked based on image processing (e.g., based on an AI model that is configured to restore three-dimensional information from video data), based on time-of-flight, based on radar, based on ultrasound, or the like, and metadata that indicate a movement of the drive actor may be generated. For example, the metadata may be generated separately from the video sequence, e.g., as a list or table of positions, orientations, angles or the like of limbs, joints, bones and/or face portions of the drive actor, and/or the position markers may be inserted as the metadata into the video sequence by an image processing program.

In some embodiments, the feature includes a character of the video sequence; and the modification of the feature includes a predetermined appearance of the character.

As mentioned, the character may correspond to a human being, to an animal, to a robot, or to any other creature or object that may serve as a character in a video sequence. The character may represent a protagonist, an antagonist, a supernumerary, a hero, a villain and/or any other person that may appear in the video sequence.

The input video data may represent the character with a simple appearance (e.g., an image of a drive actor, an uncolored model, a mesh, a character without any accessories, etc.) that may not be intended to be shown to a user, such that the circuitry may replace the representation of the character with the modification. The input video data may also represent the character with a default appearance that may be shown to a user, and the user may optionally choose to replace the character with a modified character whose appearance may be determined by the user.

The circuitry may replace the character with an AI generated character that is modified according to the consistency constraint and, possibly, to the modification instruction.

The predetermined appearance may be determined by preferences of the user, by cultural conditions, by legal requirements, etc. For example, the modification may allow to adapt the video sequence to different users, cultures and/or legislations.

In some embodiments, the predetermined appearance includes a skin color. In some embodiments, the predetermined appearance includes an ethnicity. In some embodiments, the predetermined appearance includes a gender. In some embodiments, the predetermined appearance includes a sexual orientation. In some embodiments, the predetermined appearance includes a body type. In some embodiments, the predetermined appearance includes an age.

For example, the generative AI model may adapt the skin color, ethnicity, gender, sexual orientation, body type and/or age of the character to match a skin color, ethnicity, gender, body type and/or age of the user who is watching the video sequence, such that the user may easier identify with the character.

In some embodiments, the predetermined appearance includes an outfit. In some embodiments, the predetermined appearance includes a culture. In some embodiments, the predetermined appearance includes a religion.

For example, the generative AI model may adapt the outfit, culture, religion and/or sexual orientation of the character to match a preference of the user who is watching the video sequence, to meet a cultural imprint of the user and to not disturb the user, and/or to satisfy legal requirements that may be imposed by a legislation in which the video data are offered.

For example, the present technology may allow a more generic localization of a movie, where a movie may be fully/partially modified based on the generative AI model to replace actors with an ethnicity of viewers, e.g., people of color, Hispanics, Asians, etc. As mentioned, this may allow the viewers to identify more with the plot, and may remove typical biases such as, in some instances, a majority of blockbuster movies are still dominated by white male actors.

The present technology may replace one or more actors of the video sequence with AI generated actor(s) that may represent a desired ethnicity, gender, sexual orientation, culture, religion, etc. For example, for a viewer of color, a skin tone may be adjusted. For example, a main actor may be replaced by an actress, or a heterosexual relationship may be replaced by any desired other form.

The generative AI model may modify size, skin color, facial appearance, hair, etc. of the actor (e.g., or actress), but may still maintain dramaturgical expressions of the actor.

Further, for example, the present technology may be applied to a video game, incl. extended reality (XR) content (e.g., based on a virtual reality (VR) headset). In some instances, in a known video game, it is already possible to customize one's own avatar, but not an appearance of most/all characters, such as non-playable characters (NPCs). Based on the present technology, however, a skin tone, hair, body type, gender, ethnicity, etc. of an NPC may be modified.

In some embodiments, the generating of the modification of the feature includes generating a facial expression of the modification corresponding to a facial expression of the character.

For example, the generative AI model may be trained to copy the facial expression of the character. Thus, although the modification may change an appearance of the character, information that may be conveyed by the facial expression of the character may be maintained in the modification.

In some embodiments, the generating of the modification of the feature is based on an image provided by a user.

The user may provide the image by uploading an image file, by posing in front of a camera, or the like.

For example, the present technology may allow for personalization of a movie. A viewer may upload one or more images of himself/herself, which may allow for three-dimensional reconstruction of the viewer's appearance. The circuitry (which may, e.g., be part of a streaming service) may need some time to generate a personalized movie, in which the viewer may take on a main actor's/actress's place, or the viewer may become a villain of the story, etc.

The generating of the modification of the feature based on an image provided by a user may also allow for Location-Based Entertainment (LBE). For example, at a touristic site where an interactive entertainment display is present (e.g., at Disney parks, at Universal Studios, etc.), a visitor may get incorporated into a story of an attraction or a ride based on an image of the user.

However, the present technology is not limited to modifying a character (e.g., actor) of the video sequence based on the image provided by the user, but also an object shown in the video sequence may be modified based on the image provided by the user.

For example, for localizing a commercial/advertisement, a feature of the commercial/advertisement may be modified according to the present technique, e.g., based on an image provided by the user (e.g., a creator of the commercial/advertisement). For example, a bottle of coke in a commercial/advertisement may look different in the US (e.g., English text on the bottle) than in Germany (e.g., German text on the bottle).

In some embodiments, the modification of the feature includes a representation of a predetermined accessory.

For example, for Islamic viewers, head scarfs may be inserted as a predetermined accessory for female actors.

For example, children may provide (e.g., capture, upload, etc.) an image of their toy (e.g., plush toy, toy car, etc.), and the generative AI model may include a representation of the toy in the video sequence.

In some embodiments, the modification of the feature includes a different amount of explicit content than the feature.

The generative AI model may reduce the amount of explicit content, e.g., by removing explicit content, or may increase the amount of explicit content, e.g., by inserting explicit content. The explicit content may include profanity, violence, sexual content/references, and/or other actions that may not comply with cultural, religious and/or legal requirements.

For example, the circuitry may adapt the video sequence according to a parental guidance (PG) rating. Blood/gore may be replaced/removed, sexual content (nudity) adjusted, certain gestures removed, certain food replaced (e.g., according to a religious custom).

For example, the circuitry may apply a more subtle approach than pixelating explicit content, e.g., by interpolating between a beginning and an end (e.g., pre-scene and post-scene) of a scene with explicit content in the input video data. The metadata may indicate a beginning and/or end of a scene with explicit content to facilitate replacing the explicit content with interpolated content.

For example, the circuitry may enable a more realistic video by inserting AI generated blood effects or the like according to the present technique.

In some embodiments, the input video data are associated with audio data; and the circuitry is further configured to cause the generative AI model to modify the audio data in accordance with the modification of the feature.

For example, in a case where the modification corresponds to a modified character, the circuitry (e.g., the generative AI model) may adapt the voice of the character in the audio data. For example, if a gender of the character is changed from male to female, the circuitry may adapt the voice of the character accordingly. For example, a local slang of a character may be adapted to fit to the modified character. For example, in a case where a British actor is replaced by a Hispanic actor, an Oxford English slang of the British actor may be modified into a Spanish accent.

For example, in a case where the modification changes a pet from a dog into a cat, the circuitry may adapt the audio data to include a meowing instead of a barking.

For example, in a case where the modification changes a means of transport from a car to a bicycle, the circuitry may remove an engine sound from the audio data and/or may insert a sound of a freewheeling in the audio data.

Thus, the circuitry may modify speech, a voice, an utterance, a slang, an accent, a dialect, a language, an animal sound, a machine sound, a background sound, or the like in the audio data. The skilled person may find further suitable adaptations of the audio data.

The metadata may indicate portions of the audio data that correspond to the feature. For example, the audio data may include a plurality of audio tracks, and the metadata may indicate an audio track of the plurality of audio tracks that corresponds to the feature. For example, the metadata may indicate a frequency spectrum and/or time interval of a sound in the audio data that corresponds to the feature.

In some embodiments, the modifying of the audio data includes replacing a voice represented by the audio data with a voice that corresponds to an audio sample provided by a user.

For example, in a case where the user provides an image of himself/herself for personalizing the video sequence and replacing a character of the video sequence with his/her image, as described above, the user may also provide one or more voice samples (e.g., by uploading a sound file and/or by speaking into a microphone), and the circuity may generate a personalized voice for the modified character.

In some embodiments, the generative AI model includes a plurality of portions for generating different aspects of the modification of the feature.

For example, the generative AI model may include a portion for designing an appearance of the modification, a portion for animating the modification (e.g., generating a movement of limbs of a modified character, generating a facial expression of the modified character, etc.), a portion for placing the modification into the video sequence and determining an overlap of the modification with another object in the video sequence, a portion for adapting a lighting of the modification, or the like. The skilled person may find another suitable distribution of the different aspects to the plurality of portions.

For example, the generative AI model may be configured according to a mixture of experts (MoE) technique.

Some embodiments pertain to a method that includes:
obtaining input video data and associated metadata,
   wherein the input video data represent a video sequence, and
   wherein the metadata indicate a consistency constraint for modifying a feature of the video sequence;
causing a generative artificial intelligence model to generate a modification of the feature in accordance with the consistency constraint; and
generating output video data that represent the video sequence in which the feature is replaced by the modification of the feature.

The method may correspond to the processing performed by the circuitry as described above. The method may be configured according to any feature described above with respect to the circuitry. For example, the circuitry may be configured to perform the method.

Some embodiments pertain to a system that includes:
the circuitry of any one of the embodiments described above; and
a streaming server that is configured to:
   indicate, to a user, a predetermined set of modifications of the feature;
   receive, from the user, a request for a selected modification of the set of modifications;
   obtain, from the circuitry, the output video data, wherein the output video data represent the video sequence in which the feature is replaced by the selected modification; and
   stream the output video data to the user.

The streaming server may include a processing portion, a storage portion and communication portion, as described above with respect to the circuitry. For example, the streaming server may be configured like the general-purpose computer of FIG. 8.

The streaming server may be connected to a network (e.g., internet, wide area network (WAN), local area network (LAN), etc.). The user may access the streaming server with a terminal device (e.g., smartphone, tablet, notebook, TV set, video projector, etc.) via the network and may request to receive a stream (e.g., based on Real-Time Streaming Protocol (RTSP), Real-Time Transport Protocol (RTP), Hypertext Transfer Protocol (HTTP) Live Streaming (HLS), HTTP Dynamic Streaming (HDS), Dynamic Adaptive Streaming over HTTP (DASH), Microsoft Smooth Streaming (MSS), Secure Reliable Transport (SRT), MPEG Transport Stream (MPEG-TS), Web Real-Time Communication (WebRTC), Real-Time Messaging Protocol (RTMP), User Datagram Protocol (UDP), or the like) of a movie from the streaming server.

Upon receiving the request, the streaming server may present the set of modifications to the user in a user interface. For example, the streaming server may cause the terminal device of the user to display indications of the set of modifications. For example, the terminal device may display the indications as a drop-down menu, as buttons, as a list, as tiles or the like, such that the user may select a modification by clicking or tapping the corresponding modification. The terminal device may also allow the user to select a modification by performing a control gesture, by uttering a voice command, etc.

The set of modifications of the feature may be determined, for example, by a creator of the input video data and/or by an operator of the streaming server. For example, the set of modifications may correspond to modifications that the operator of the streaming server wants to allow, e.g., based on cultural conditions and/or legal requirements at a place where the streaming server is operated and/or from where access to the streaming server is provided.

The user may select one of the modifications and may request the modification from the streaming server. The streaming server may receive the request from the user via the network and may obtain the corresponding output video data from the circuitry. The streaming server may stream the received output video data via the network to the terminal device of the user, such that the user may watch the requested movie in which the feature has been replaced by the selected modification.

For example, the streaming server may input, to the circuitry, input video data that correspond to the selected movie, together with associated metadata and with a modification instruction that corresponds to the requested modification. The circuitry may perform the processing described above according to the received metadata and modification instruction, and may output corresponding output video data, which the streaming server may stream to the user.

Thus, the streaming server may provide a streaming service that may offer a drop-down menu with various settings that may allow more diversity (e.g., similar to a known selection of a language of a movie).

In some embodiments, the system further includes a storage portion; and
the streaming server is further configured to:
store the obtained output video data in the storage portion; and
stream the output video data from the storage portion to the user.

For example, generating the output video data may take some time to finish. For avoiding that the user has to wait for the generating of the output video data, the streaming server may cause the circuitry to generate the output video data in advance (e.g., before the corresponding movie is offered by the streaming server, or at least before the streaming server receives the request from the user).

The storage portion may be included in the streaming server (e.g., as a HDD, as an SDD, etc.), and/or the storage portion may be configured as a network storage (e.g., based on network-attached storage (NAS), Amazon S3, Network File System (NFS), Server Message Block (SMB), Common Internet File System (CIFS), Internet Small Computer System Interface (iSCSI), Fibre Channel (FC), etc.), and the streaming server may access the storage portion via the network.

Thus, the content may be pre-rendered and stored in the storage portion, e.g., on the streaming server and/or may be kept available in a storage portion at a local server in a region where a certain ethnicity may be over-represented.

Thus, a waiting time of the user for receiving the stream of the movie with the selected modification may be reduced by storing output video data that represent the pre-rendered movie on the storage portion.

Some embodiments pertain to a system that includes:
the circuitry of any one of the embodiments described above;
first glasses with a first transmission characteristic;
second glasses with a second transmission characteristic different from the first transmission characteristic; and
a display portion that is configured to:
   obtain, from the circuitry, first output video data and second output video data,
      wherein the first output video data represent the video sequence in which the feature is replaced by the modification, and
      wherein the second output video data represent the video sequence in which the feature is not replaced by the modification;
   output a first display according to the first output video data at a first output characteristic that corresponds to the first transmission characteristic, such that the first display is transmitted by the first glasses and blocked by the second glasses; and
   output a second display according to the second output video data at a second output characteristic that corresponds to the second transmission characteristic, such that the second display is transmitted by the second glasses and blocked by the first glasses.

The first and second glasses may be worn by users who want to watch a movie, e.g., in a movie theater. The display portion may output the movie to the users, e.g., by projecting the movie onto a screen, by displaying the movie on a liquid-crystal display (LCD), on a light-emitting diode (LED) display, on an organic LED (OLED) display, on a quantum dot LED (QLED) display, on a plasma display, on a cathode ray tube (CRT) display, or the like.

The users may prefer different modifications of a feature of the movie. For example, a first group of the users may prefer replacing the feature by the modification, and a second group of the users may prefer the original movie without replacing the feature by the modification, or the second group of the users may prefer replacing the feature by another modification. For example, while a protagonist of the movie may have a white skin color, the first group of the users may prefer a protagonist with a black skin color, and the second group of the users may prefer a protagonist with an Asian appearance.

Thus, the circuitry may generate the first output video data with the modification and the second output video data in which the feature is not replaced by the modification (but in which the (original) feature is kept, or in which the feature is replaced by another modification). The modification may correspond to replacing the protagonist in the movie with a character that has a black skin color. Likewise, the other modification may correspond to replacing the protagonist in the movie with a character that has an Asian appearance.

The display portion may output the first display (which may correspond to the modification) at the first output characteristic, such that users who are wearing the first glasses may see the movie with a black protagonist according to the modification. Likewise, the display portion may output the second display (which may correspond to the other modification) at the second output characteristic, such that users who are wearing the second glasses may see the movie with an Asian protagonist. Or, as mentioned, the second display may correspond to the original movie without replacing the feature by a modification, such that users who are wearing the second glasses may see the original movie.

For example, the first group of users may wear the first glasses, and the second group of users may wear the second glasses. Thus, both the first and second group of users may be sitting in the same movie theater and watching the movie with their respective preferred versions of the feature (e.g., original or modification) at a same time on a same screen/display, because the glasses may transmit light that corresponds to the movie with their respective preferred version and may block light that corresponds to the movie without their respective preferred version.

The present technique is not limited to a movie theater, but may as well be applied wherever users with different preferences watch a movie (or any other video sequence, as described above) together, e.g., in a living room, in an open-air screening of a sporting event, on a stage display at a concert, at a screen that displays commercials in a shopping mall, etc.

Further, depending on a technique underlying the first and second transmission characteristics and/or the first and second output characteristics, the display portion may output more than two different displays such that more than two groups of users may watch a video sequence with more than two different respective versions of the feature (e.g., original and/or modification(s)).

In some embodiments, the first transmission characteristic corresponds to transmitting light during first time intervals and blocking light during second time intervals;
the second transmission characteristic corresponds to transmitting light during the second time intervals and blocking light during the first time intervals;
the first time intervals and the second time intervals alternate; and
the display portion is configured to output the first display during the first time intervals and to output the second display during the second time intervals.

The first and second time intervals may be interleaved such that a first time interval may be between two consecutive second time intervals, and vice versa.

The first and second glasses and the display portion may be synchronized, for example, based on a time signal (e.g., Network Time Protocol (NTP), Precision Time Protocol (PTP), Cell Broadcast Time Information (CBTI), Global Positioning System (GPS), Bluetooth, Wi-Fi, etc.) and/or based on clock signal (e.g., based on infrared and/or based on displaying clock information by the display portion, e.g., as an overlay on the first and/or second display).

The first output characteristic may correspond to outputting the first display during the first time intervals, and the second output characteristic may correspond to outputting the second display during the second time intervals.

Thus, in the first time intervals, the display portion may output the first display (which may correspond to the modification of the feature) according to the first output characteristic, and the first glasses may be transparent according to the first transmission characteristic, such that the first group of users (who may be wearing the first glasses) may see the first display. The second glasses may be opaque in the first time intervals such that the second group of users (who may be wearing the second glasses) may not see the first display.

Likewise, in the second time intervals, the display portion may output the second display (which may correspond to the original feature or to another modification of the feature) according to the second output characteristic, and the second glasses may be transparent according to the second transmission characteristic, such that the second group of users may see the second display. The first glasses may be opaque in the second time intervals such that the first group of users may not see the second display.

For example, a first or second time interval may correspond to half a duration of a video frame of the first and/or second output video data, and the display portion may switch between the first and second display at twice a frame rate of the first and/or second output video data. However, the present disclosure is not limited to this duration of the first or second time intervals. For example, in a case where the display portion further outputs at third time intervals a third display, which may correspond to a further modification, a duration of a first, second or third time interval may correspond to a third of a duration of a video frame of the first, second and/or third output video data. Accordingly, an output frame rate of the display portion may be higher than the frame rate of the first, second and/or third output video data.

An opacity and/or transmittance of the first and second glasses may, for example, be controlled based on liquid crystal technology.

In some instances, for 3D movies, certain shutter glasses are used that allow filtering out every second frame, alternating for each eye. If a frame rate and/or shutter speed is further upscaled, such a technique may be used according to the present disclosure to allow a large and diverse audience in a movie theater to watch their own modified content. For example, some viewers may see the movie with Hispanic actors, some with people of color, and so on.

In some embodiments, the first transmission characteristic corresponds to transmitting light of a first polarization and blocking light of a second polarization;
the second transmission characteristic corresponds to transmitting light of the second polarization and blocking light of the first polarization; and
the display portion is configured to output the first display with light of the first polarization and to output the second display with light of the second polarization.

The first and second polarizations may be orthogonal. For example, the first polarization may correspond to a horizontal polarization and the second polarization may correspond to a vertical polarization, or vice versa. The first and second polarizations may also correspond to any other polarization directions that differ by 90 degrees. Further, for example, the first polarization may correspond to a clockwise circular (or elliptical) polarization and the second polarization may correspond to a counter-clockwise circular (or elliptical) polarization, or vice versa.

The first and second glasses may be manufactured, e.g., based on polyvinyl alcohol (PVA) with iodine coating, based on thin metal grids (wire grid polarizer), based on a birefringent crystal (e.g., calcite, mica, etc.), based on a dichroic material, based on a quarter-wave plate (QWP; e.g., based on a birefringent material such as mica, quartz and/or a polymer film), based on a nanostructured material, or the like.

The display portion may include switchable polarization filters (e.g., a rotating disk wherein a first sector includes a polarizing portion according to the first polarization and a second sector includes a polarizing portion according to the second polarization); a QWP; fixed polarization filters according to the first and second polarizations, respectively; a polarized light source (e.g., laser, or a halogen lamp with a polarization filter) that may be rotated by a motor and/or whose emitted light may be rotated by a mirror; two polarized light sources that correspond to the first and second polarizations, respectively, that are directed at a same screen, or any other suitable technique.

The first output characteristic may correspond to outputting the first display according to the first polarization, and the second output characteristic may correspond to outputting the second display according to the second polarization, such that the first group of users (who may be wearing the first glasses) may see the first display (which may correspond to the modification), and the second group of users (who may be wearing the second glasses) may see the second display (which may correspond to the video sequence without the modification but, e.g., with the (original) feature or with another modification).

The display portion may output the first and second display simultaneously, or the display portion may output the first and second display at alternating time intervals, as described for the preceding embodiment.

In some embodiments, the display portion is configured to output the first display and the second display on a same screen.

Thus, the first and second (and, possibly any further) groups of users may watch the movie by looking at the same screen, but may see the movie in their respective preferred versions (e.g., in an original version and/or with their respective preferred modification) due to the first and second (and, possibly, any further) transmission/output characteristics.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, FIG. 1 illustrates an embodiment of circuitry 1. The circuitry 1 includes a processing portion 2, a storage portion 3 and a communication portion 4. The processing portion 2 controls a function of the circuitry 1 and performs the data processing described herein. The storage portion 3 stores firmware and software instructions that are executed by the processing portion 2 as well as data that are read and/or stored by the processing portion 2 during the processing described herein. The communication portion 4 receives input video data and associated metadata, and transmits output video data generated by the processing portion 2 according to the processing described herein.

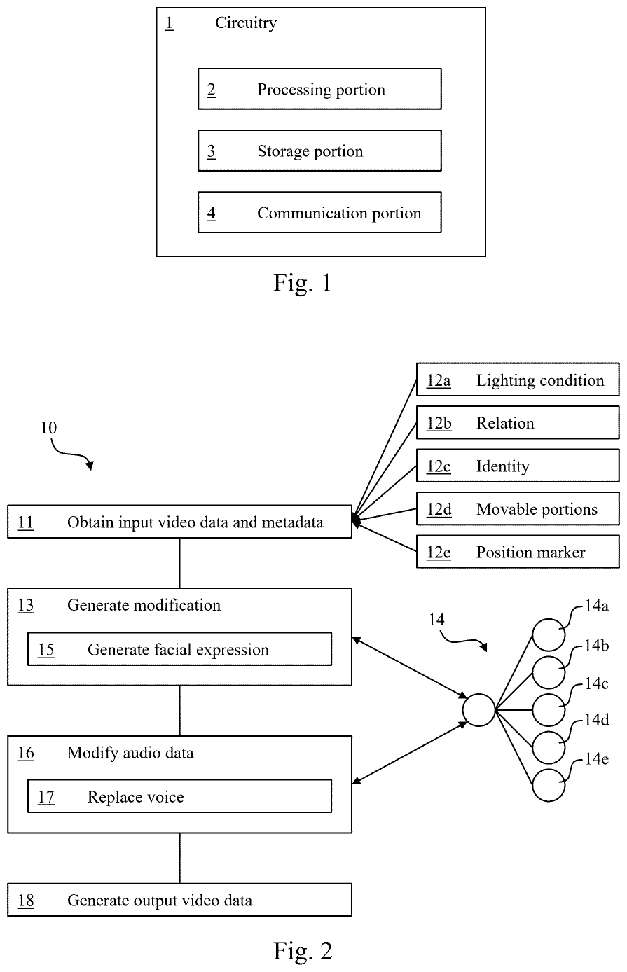

FIG. 2 illustrates an embodiment of a method 10. The method 10 is an example of a processing performed by the circuitry 1 of FIG. 1. The circuitry 1 is configured to perform the method 10.

At 11, the circuitry 1 obtains input video data and associated metadata. The input video data represent a video sequence. The metadata indicate a consistency constraint for modifying a feature of the video sequence. The consistency constraint indicates a criterion for the modification of the feature for maintaining a consistency of the modification with the video sequence.

The consistency constraint indicates a lighting condition 12a of the feature. The consistency constraint indicates a relation 12b between the feature and another feature of the video sequence. The consistency constraint indicates an identity 12c of the feature with another feature of the video sequence. Further, the feature includes movable portions, and the consistency constraint indicates a position 12d of the movable portions in the video sequence. Further, the feature includes a representation of a drive actor, and the metadata include a position marker 12e in the representation of the drive actor.

At 13, the circuitry 1 cause a generative artificial intelligence (AI) model 14 to generate a modification of the feature in accordance with the consistency constraint. The generative AI model 14 includes a plurality of portions 14a to 14e for generating different aspects of the modification of the feature.

Further, the feature includes a character of the video sequence, and the modification of the feature includes a predetermined appearance of the character. Thus, the generating of the modification of the feature at 13 includes generating, at 15, a facial expression of the modification corresponding to a facial expression of the character.

The input video data are further associated with audio data. Thus, at 16, the circuitry 1 causes the generative AI model 14 to modify the audio data in accordance with the modification of the feature. The modifying of the audio data at 16 includes replacing, at 17, a voice represented by the audio data with a voice that corresponds to an audio sample provided by a user.

At 18, the circuitry 1 generates output video data that represent the video sequence in which the feature is replaced by the modification of the feature.

It is noted that, in some embodiments, the metadata obtained at 11 include only one or some of the consistency constraints 12a to 12e.

Further, in some embodiments, (e.g., if the feature does not include a character of the video sequence), the generating of the facial expression at 15 is omitted.

Further, in some embodiments, the replacing of the voice at 17 is omitted, or (e.g., if the input video data are not associated with audio data) the modifying of the audio data at 16 is omitted.

Also, in some embodiments, the generative AI model 14 is configured as a general AI model without a distribution of specific tasks to specific portions.

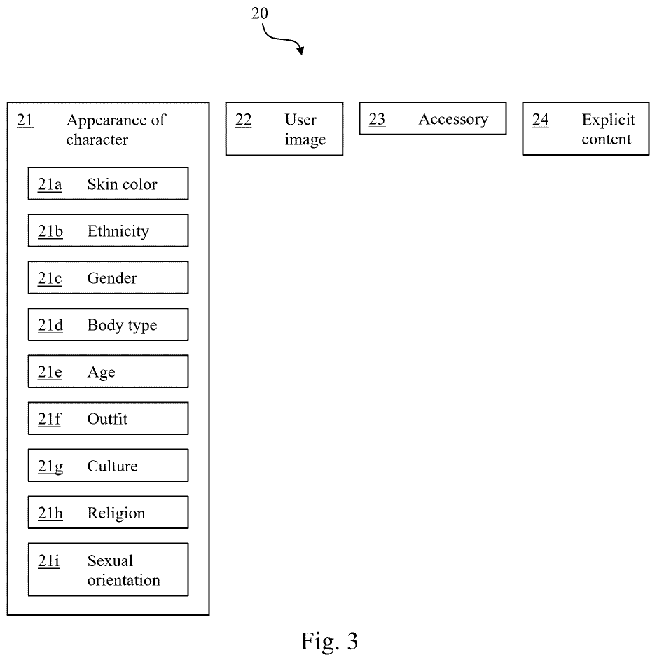

FIG. 3 illustrates examples of modifications 20 of the feature according to an embodiment. The modifications 20 are examples of modifications that are generated at 13 of FIG. 2 by the generative AI model 14.

In the embodiment of FIG. 3, the feature includes a character of the video sequence, and a modification 20 of the feature includes a predetermined appearance 21 of the character. The predetermined appearance 21 includes a skin color 21a of the character, an ethnicity 21b of the character, a gender 21c of the character, a body type 21d of the character, an age 21e of the character, an outfit 21f of the character, a culture 21g of the character, a religion 21h of the character, and a sexual orientation 21i of the character.

Also, in the embodiment of FIG. 3, a modification 20 of the feature is based on an image 22 provided by a user.

Further, in the embodiment of FIG. 3, a modification 20 of the feature includes a representation of a predetermined accessory 23 and a different amount of explicit content 24 than the feature.

It is noted that, in some embodiments, only one or some of the examples of modifications 20 of FIG. 3 are realized. For example, only one or some of the modifications 21, 22, 23 and 24 may be realized, and/or only one or some of the examples 21a to 21i of the appearance 21 of the character may be realized.

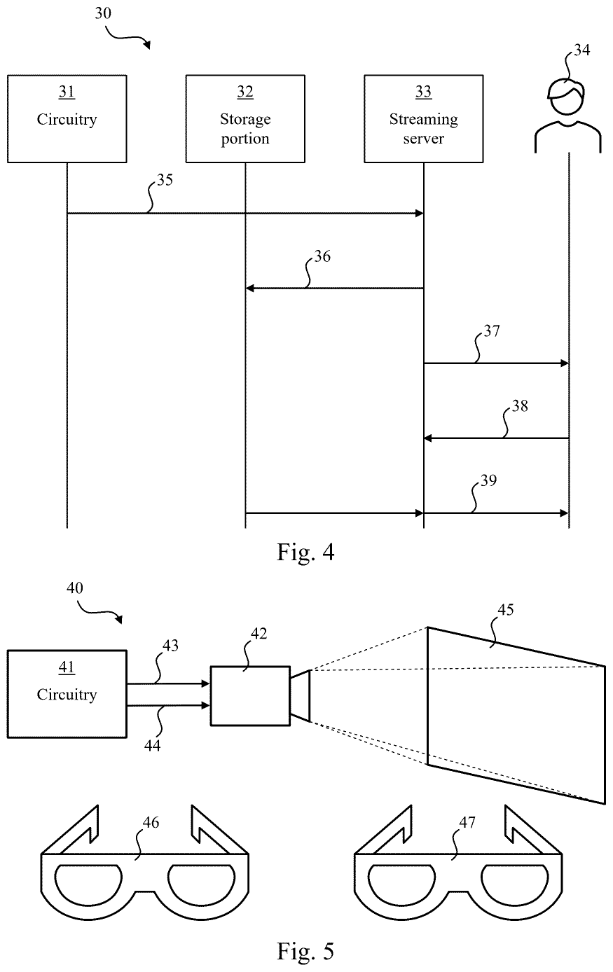

FIG. 4 illustrates a first embodiment of a system 30. The system 30 includes circuitry 31 (an example of the circuitry 1, configured to perform the method 10 of FIG. 2), a storage portion 32, and a streaming server 33.

At 35, the streaming server 33 obtains, from the circuitry 31, output video data, which represent a video sequence in which a feature is replaced by a modification.

At 36, the streaming server 33 stores the output video data obtained at 35 in the storage portion 32.

At 37, the streaming server 33 indicates, to a user 34, a predetermined set of modifications of the feature. The predetermined set of modifications includes the modification of the output video data obtained at 35.

At 38, the streaming server 33 receives, from the user 34, a request for a selected modification of the set of modifications. The selected modification corresponds to the modification of the output video data obtained at 35.

At 39, the streaming server 33 streams the output video data from the storage portion 32 to the user 34.

It is noted that, in some embodiments, the obtaining of the output video data at 35 and the storing of the output video data at 36 is performed after the receiving of the request at 38.

It is also noted that, in some embodiments, the system 30 does not include the storage portion 32, and the streaming server 33 streams the output video data obtained at 35 from the circuitry 31 to the user 34 without storing the output video data at 36 in the storage portion 32.

FIG. 5 illustrates a second embodiment of a system 40. The system 40 includes circuitry 41 (an example of the circuitry 1, configured to perform the method 10 of FIG. 2) and a display portion 42. The display portion 42 obtains, from the circuitry 41, first output video data 43 and second output video data 44, as indicated by arrows in FIG. 5.

The first output video data 43 represent a video sequence in which a feature is replaced by a modification, and the second output video data 44 represent the video sequence in which the feature is not replaced by the modification.

The system 40 further includes first glasses 46 with a first transmission characteristic and second glasses 47 with a second transmission characteristic different form the first transmission characteristic.

The display portion 42 is configured as a projector and, as indicated by dashed lines, outputs, on a same screen 45, a first display and a second display. The display portion 42 outputs the first display according to the first output video data 43 at a first output characteristic that corresponds to the first transmission characteristic, such that the first display is transmitted by the first glasses 46 and blocked by the second glasses 47. The display portion 42 further outputs the second display according to the second output video data 44 at a second output characteristic that corresponds to the second transmission characteristic, such that the second display is transmitted by the second glasses 47 and blocked by the first glasses 46.

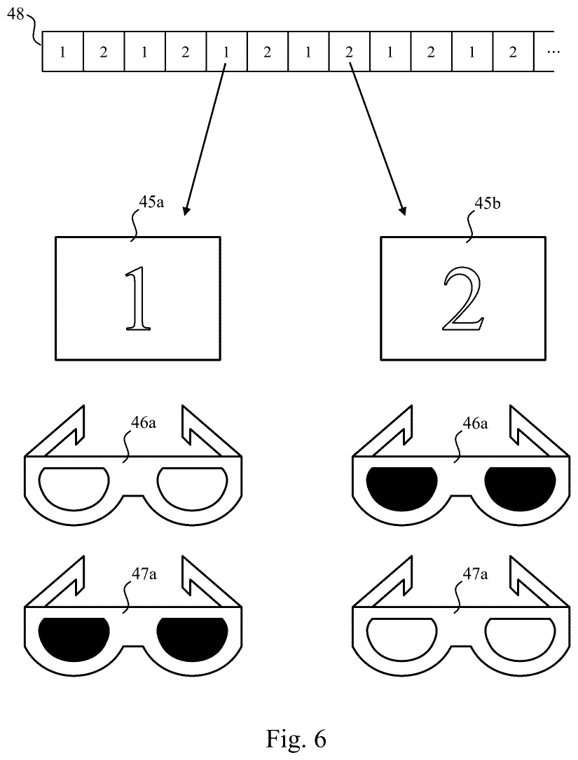

FIG. 6 illustrates a first embodiment of outputting a first display and a second display by the display portion 42 of FIG. 5.

In the embodiment of FIG. 6, the first transmission characteristic corresponds to transmitting light during first time intervals and blocking light during second time intervals, and the second transmission characteristic corresponds to transmitting light during the second time intervals and blocking light during the first time intervals.

The first time intervals are indicated by a “1” in a timeline 48, and the second time intervals are indicated by a “2” in the timeline 48. As illustrated in the timeline 48, the first time intervals and the second time intervals alternate.

The display portion 42 outputs the first display during the first time intervals and outputs the second display during the second time intervals.

A left column of FIG. 6 illustrates a first time interval. The display portion 42 outputs the first display, as illustrated by an image 45a displayed on the screen 45 in the first time interval. In the first time interval, first glasses 46a (an example of the first glasses 46 of FIG. 5) transmit light (as illustrated by white lenses) and second glasses 47a (an example of the second glasses 47 of FIG. 5) block light (as illustrated by black lenses).

A right column of FIG. 6 illustrates a second time interval. The display portion 42 outputs the second display, as illustrated by an image 45b displayed on the screen 45 in the second time interval. In the second time interval, the first glasses 46a block light and the second glasses 47a transmit light.

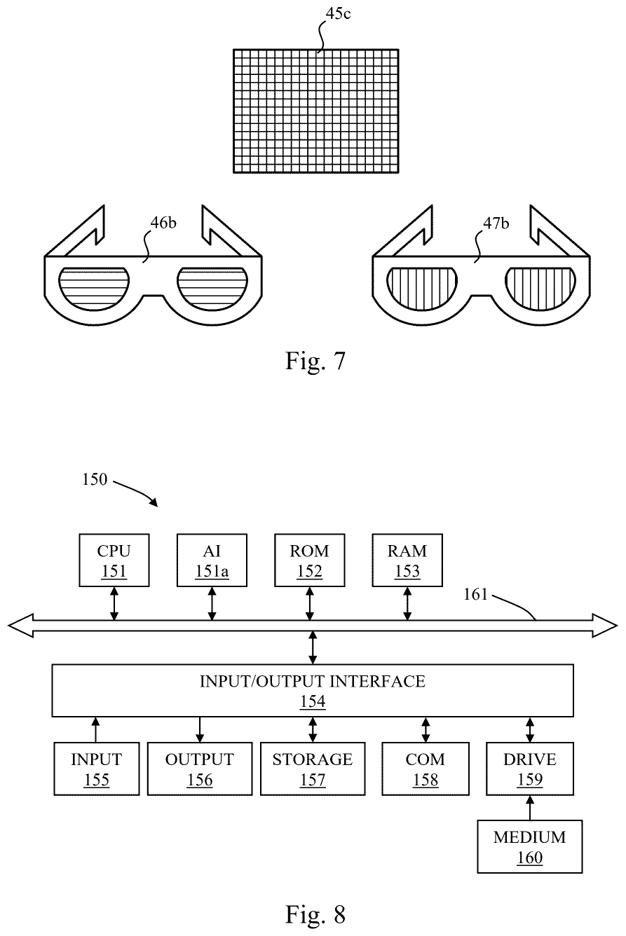

FIG. 7 illustrates a second embodiment of outputting a first display and a second display by the display portion 42 of FIG. 5.

In the embodiment of FIG. 7, the first transmission characteristic corresponds to transmitting light of a first polarization and blocking light of a second polarization, as indicated by a horizontal hatching of first glasses 46b (an example of the first glasses 46 of FIG. 5), and the second transmission characteristic corresponds to transmitting light of the second polarization and blocking light of the first polarization, as indicated by a vertical hatching of second glasses 47b (an example of the second glasses 47 of FIG. 5).

The display portion 42 outputs the first display with light of the first polarization and outputs the second display with light of the second polarization on the same screen 45, as illustrated by both a horizontal and a vertical hatching of an image 45c displayed on the screen 45.

It is noted that, although the first and second polarizations are illustrated as horizontal and vertical hatching, respectively, the first and second polarizations may have any other suitable polarization than horizontal and vertical, as described herein.

In summary, the present disclosure provides generative AI for inclusive, diverse and/or personalized content in movies, games and/or any other video sequences. Some embodiments allow avoiding a complete re-shooting of a movie for modifying a feature of the movie. Also, re-mastering of existing old movies may be adjusted to modern day's needs (e.g., in terms of diversity and inclusiveness).

As mentioned, the present technology is not limited to movies, series or shows, but may also be applied to video games and/or commercials. For example, the circuitry may modify a feature in a computer game in real time.

In some embodiments, only a director/producer (or any other content creator, e.g. a studio) of a movie (or of any other video sequence) can allow for the functionality to maintain/preserve the intended play of the movie. For example, a content creator may define limitations (e.g., may predefine an analysis after modifying the feature to determine whether the modification meets a modification policy defined as consistency constraint in the metadata). For example, the content creator may forbid changing a certain character of the video sequence, e.g., by inserting a corresponding indication as a consistency constraint in the metadata, and/or by not including, in the metadata, consistency constraints that indicate a lighting condition, depth information, a semantic relation (e.g., an identity of the character with another character in another scene) of the character, such that modifying the character without the consistency constraint may result in an unsatisfactory (e.g., inconsistent, unnatural and/or illogical) modification. The limitations imposed by the consistency constraint may differ between regions (e.g., countries, culture areas, etc.) according to a local culture and/or jurisdiction.

The limitations (e.g., the consistency constraint) may be cryptographically secured (e.g., based on a symmetric key (e.g., according to Advanced Encryption Standard (AES), and/or based on asymmetric encryption (e.g., according to Rivest-Shamir-Adleman (RSA) and/or Elliptic Curve Cryptography (ECC)), for example, by signing the consistency constraint. The director, producer, studio or other content creator who defines the limitations may keep a secret (e.g., symmetric key, private key, or the like) for securing the consistency constraint and may change the consistency constraint at a later time based on the secret. For example, if due to political reasons, a symbol or other content used/included in footage of the video sequence becomes banned due to a political event (which, in some cases, may not be foreseeable at a time of creating the video sequence), the director or studio or the like may change the consistency constraint to allow removing/replacing the banned symbol or other content based on the secret to account for the change in a political/legal environment. Thus, a list of potential modifications according to the consistency constraint may be changed over time, whereas unauthorized changes to the consistency constraint may be prevented cryptographically. The changes to the limitations imposed by the consistency constraint may apply to specific regions (e.g., countries, culture areas, etc.) and may, for example, differ between regions, according to a local culture, jurisdiction and/or political/legal environment.

As mentioned, to allow easier AI modifications, drive actors may be used. The drive actors may act as generic actors, and may possibly not appear in the final movie. Their main task may be acting, wherein their appearance may not be important. This may open a new profession for actors who do not disclose their identity in a final product (e.g., movie, show, commercial, etc.), but have a skillset for performing as drive actors, whose faces may then be overlaid with AI generated faces according to the technique disclosed herein. This may open more inclusivity for actors who might not meet a director's requirements to physical appearance, but who may have right acting and performance skills for a role. Also, somebody who doesn't speak a target language of a movie may perform as drive actor, as language information may be later adjusted using generative AI methods. For example, as mentioned, the drive actors may be equipped with markers (e.g., on their face and/or body) for better detection of keypoints (e.g., limbs, joints, face features etc.), which may allow for a better replacement according to the present technique.

FIG. 8 illustrates an embodiment of a general-purpose computer 150. The general-purpose computer 150 can be implemented such that it can basically function as any type of mobile device, for example, a smartphone, smart glasses, a head-mounted display, a smartwatch, a mobile phone, a mobile tablet, a notebook, a terminal device, a streaming server or the like. The general-purpose computer 150 is an example of circuitry (e.g., the circuitry 1 of FIG. 1, the circuitry 31 of FIG. 4, and/or the circuitry 41 of FIG. 5) that is configured to perform the method according to the present technology (e.g., the method 10 of FIG. 2). The computer 150 has components 151 to 161, which can form a circuitry, such as any one of the portion 2, the portion 3, the portion 4, or the like, as described herein. The computer 150 can also be configured as the streaming server 33 and/or the storage portion 32 of FIG. 4.

Embodiments which use software, firmware, programs or the like for performing the methods as described herein can be installed on computer 150, which is then configured to be suitable for the concrete embodiment.

The computer 150 has a CPU 151 (Central Processing Unit), which can execute various types of procedures and methods as described herein, for example, in accordance with programs stored in a read-only memory (ROM) 152, stored in a storage 157 and loaded into a random-access memory (RAM) 153, stored on a medium 160 which can be inserted in a respective drive 159, etc.

Furthermore, the computer 150 includes an artificial intelligence (AI) processor 151a. The AI processor 151a may include a graphics processing unit (GPU) and/or a tensor processing unit (TPU). The AI processor 151a may be configured to execute an AI model (e.g., an artificial neural network), for example, the generative AI model 14 of FIG. 2.

The CPU 151, the ROM 152 and the RAM 153 are connected with a bus 161, which in turn is connected to an input/output interface 154. The number of CPUs, memories and storages is only exemplary, and the skilled person will appreciate that the computer 150 can be adapted and configured accordingly for meeting specific requirements which arise when it functions as an information processing apparatus according to the present technology.

At the input/output interface 154, several components are connected: an input 155, an output 156, the storage 157, a communication interface 158 and the drive 159, into which a medium 160 (compact disc (CD), digital video disc (DVD), universal serial bus (USB) flash drive, secure digital (SD) card, CompactFlash (CF) memory, or the like) can be inserted.

The input 155 can be a pointer device (mouse, graphic table, or the like), a keyboard, a microphone, a camera, a touchscreen, an eye-tracking unit etc.

The output 156 can have a display (liquid crystal display (LCD), cathode ray tube (CRT) display, light-emitting diode (LED) display, electronic paper, etc.; e.g., included in a touchscreen), loudspeakers, etc.

The storage 157 can have a hard disk drive (HDD), a solid-state drive (SSD), a flash drive and the like.

The communication interface 158 can be adapted to communicate, for example, via universal serial bus (USB), a serial port (RS-232), parallel port (IEEE 1284), a local area network (LAN; e.g., ethernet), wireless local area network (WLAN; e.g., Wi-Fi, IEEE 802.11), mobile telecommunications system (GSM, UMTS, LTE, NR etc.), Bluetooth, near-field communication (NFC), ZigBee, infrared, etc.

It should be noted that the description above only pertains to an example configuration of computer 150. Alternative configurations may be implemented with additional or other sensors, storage devices, interfaces or the like. For example, the communication interface 158 may support other radio access technologies than the mentioned UMTS, LTE and NR.

It should be recognized that the embodiments describe methods with an exemplary ordering of method steps. The specific ordering of method steps is however given for illustrative purposes only and should not be construed as binding. Changes of the ordering of method steps may be apparent to the skilled person.

Please note that the division of the circuitry 1 into portions 2 to 4 is only made for illustration purposes and that the present disclosure is not limited to any specific division of functions in specific portions. For instance, the circuitry 1 could be implemented by a respective programmed processor, field programmable gate array (FPGA) and the like.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) Circuitry, configured to:
obtain input video data and associated metadata,
   wherein the input video data represent a video sequence, and
   wherein the metadata indicate a consistency constraint for modifying a feature of the video sequence;
cause a generative artificial intelligence model to generate a modification of the feature in accordance with the consistency constraint; and
generate output video data that represent the video sequence in which the feature is replaced by the modification of the feature.

(2) The circuitry of (1),
wherein the consistency constraint indicates a criterion for the modification of the feature for maintaining a consistency of the modification with the video sequence.

(3) The circuitry of (1) or (2),
wherein the consistency constraint indicates a lighting condition of the feature.

(4) The circuitry of any one of (1) to (3),
wherein the consistency constraint indicates a relation between the feature and another feature of the video sequence.

(5) The circuitry of any one of (1) to (4),
wherein the consistency constraint indicates an identity of the feature with another feature of the video sequence.

(6) The circuitry of any one of (1) to (5),
wherein the feature includes movable portions; and
wherein the consistency constraint indicates a position of the movable portions in the video sequence.

(7) The circuitry of any one of (1) to (6),
wherein the feature includes a representation of a drive actor; and
wherein the metadata include a position marker in the representation of the drive actor.

(8) The circuitry of any one of (1) to (7),
wherein the feature includes a character of the video sequence; and
wherein the modification of the feature includes a predetermined appearance of the character.

(9) The circuitry of (8),
wherein the predetermined appearance includes a skin color.

(10) The circuitry of (8) or (9),
wherein the predetermined appearance includes an ethnicity.

(11) The circuitry of any one of (8) to (10),
wherein the predetermined appearance includes a gender.

(12) The circuitry of any one of (8) to (11),
wherein the predetermined appearance includes a body type.

(13) The circuitry of any one of (8) to (12),
wherein the predetermined appearance includes an age.

(14) The circuitry of any one of (8) to (13),
wherein the predetermined appearance includes an outfit.

(15) The circuitry of any one of (8) to (14),
wherein the predetermined appearance includes a culture.

(16) The circuitry of any one of (8) to (15),
wherein the predetermined appearance includes a religion.

(17) The circuitry of any one of (8) to (16),
wherein the predetermined appearance includes a sexual orientation.

(18) The circuitry of any one of (8) or (17),
wherein the generating of the modification of the feature includes generating a facial expression of the modification corresponding to a facial expression of the character.

(19) The circuitry of any one of (1) to (18),
wherein the generating of the modification of the feature is based on an image provided by a user.

(20) The circuitry of any one of (1) to (19),
wherein the modification of the feature includes a representation of a predetermined accessory.

(21) The circuitry of any one of (1) to (20),
wherein the modification of the feature includes a different amount of explicit content than the feature.

(22) The circuitry of any one of (1) to (21),
wherein the input video data are associated with audio data; and
wherein the circuitry is further configured to cause the generative artificial intelligence model to modify the audio data in accordance with the modification of the feature.

(23) The circuitry of (22),
wherein the modifying of the audio data includes replacing a voice represented by the audio data with a voice that corresponds to an audio sample provided by a user.

(24) The circuitry of any one of (1) to (23),
wherein the generative artificial intelligence model includes a plurality of portions for generating different aspects of the modification of the feature.

(25) A method, comprising:
obtaining input video data and associated metadata,
   wherein the input video data represent a video sequence, and
   wherein the metadata indicate a consistency constraint for modifying a feature of the video sequence;
causing a generative artificial intelligence model to generate a modification of the feature in accordance with the consistency constraint; and
generating output video data that represent the video sequence in which the feature is replaced by the modification of the feature.

(26) The method of (25),
wherein the consistency constraint indicates a criterion for the modification of the feature for maintaining a consistency of the modification with the video sequence.

(27) The method of (25) or (26),
wherein the consistency constraint indicates a lighting condition of the feature.

(28) The method of any one of (25) to (27),
wherein the consistency constraint indicates a relation between the feature and another feature of the video sequence.

(29) The method of any one of (25) to (28),
wherein the consistency constraint indicates an identity of the feature with another feature of the video sequence.

(30) The method of any one of (25) to (29),
wherein the feature includes movable portions; and
wherein the consistency constraint indicates a position of the movable portions in the video sequence.

(31) The method of any one of (25) to (30),
wherein the feature includes a representation of a drive actor; and
wherein the metadata include a position marker in the representation of the drive actor.

(32) The method of any one of (25) to (31),
wherein the feature includes a character of the video sequence; and
wherein the modification of the feature includes a predetermined appearance of the character.

(33) The method of (32),
wherein the predetermined appearance includes a skin color.

(34) The method of (32) or (33),
wherein the predetermined appearance includes an ethnicity.

(35) The method of any one of (32) to (34),
wherein the predetermined appearance includes a gender.

(36) The method of any one of (32) to (35),
wherein the predetermined appearance includes a body type.

(37) The method of any one of (32) to (36),
wherein the predetermined appearance includes an age.

(38) The method of any one of (32) to (37),
wherein the predetermined appearance includes an outfit.

(39) The method of any one of (32) to (38),
wherein the predetermined appearance includes a culture.

(40) The method of any one of (32) to (39),
wherein the predetermined appearance includes a religion.

(41) The method of any one of (32) to (40),
wherein the predetermined appearance includes a sexual orientation.

(42) The method of any one of (32) to (41),
wherein the generating of the modification of the feature includes generating a facial expression of the modification corresponding to a facial expression of the character.

(43) The method of any one of any one of (25) to (42),
wherein the generating of the modification of the feature is based on an image provided by a user.

(44) The method of any one of (25) to (43),
wherein the modification of the feature includes a representation of a predetermined accessory.

(45) The method of any one of (25) to (44),
wherein the modification of the feature includes a different amount of explicit content than the feature.

(46) The method of any one of (25) to (45),
wherein the input video data are associated with audio data; and
wherein the method further comprises causing the generative artificial intelligence model to modify the audio data in accordance with the modification of the feature.

(47) The method of (46),
wherein the modifying of the audio data includes replacing a voice represented by the audio data with a voice that corresponds to an audio sample provided by a user.

(48) The method of any one of (25) to (47),
wherein the generative artificial intelligence model includes a plurality of portions for generating different aspects of the modification of the feature.

(49) A system, comprising:
the circuitry of any one of (1) to (24); and
a streaming server configured to:
indicate, to a user, a predetermined set of modifications of the feature;
receive, from the user, a request for a selected modification of the set of modifications;
obtain, from the circuitry, the output video data, wherein the output video data represent the video sequence in which the feature is replaced by the selected modification; and
stream the output video data to the user.

(50) The system of (49),
wherein the system further comprises a storage portion; and
wherein the streaming server is further configured to:
   store the obtained output video data in the storage portion; and
   stream the output video data from the storage portion to the user.

(51) A system, comprising:
the circuitry of any one of (1) to (24);
first glasses with a first transmission characteristic;
second glasses with a second transmission characteristic different from the first transmission characteristic; and
a display portion configured to:
   obtain, from the circuitry, first output video data and second output video data,
      wherein the first output video data represent the video sequence in which the feature is replaced by the modification, and
      wherein the second output video data represent the video sequence in which the feature is not replaced by the modification;
   output a first display according to the first output video data at a first output characteristic that corresponds to the first transmission characteristic, such that the first display is transmitted by the first glasses and blocked by the second glasses; and
   output a second display according to the second output video data at a second output characteristic that corresponds to the second transmission characteristic, such that the second display is transmitted by the second glasses and blocked by the first glasses.

(52) The system of (51),
wherein the first transmission characteristic corresponds to transmitting light during first time intervals and blocking light during second time intervals;
wherein the second transmission characteristic corresponds to transmitting light during the second time intervals and blocking light during the first time intervals;
wherein the first time intervals and the second time intervals alternate; and
wherein the display portion is configured to output the first display during the first time intervals and to output the second display during the second time intervals.

(53) The system of (51) or (52),
wherein the first transmission characteristic corresponds to transmitting light of a first polarization and blocking light of a second polarization;
wherein the second transmission characteristic corresponds to transmitting light of the second polarization and blocking light of the first polarization; and
wherein the display portion is configured to output the first display with light of the first polarization and to output the second display with light of the second polarization.

(54) The system of any one of (51) to (53),
wherein the display portion is configured to output the first display and the second display on a same screen.

(55) A computer program comprising program code causing a computer to perform the method according to any one of (25) to (48), when being carried out on a computer.

(56) A non-transitory computer-readable recording medium that stores therein a computer program product, which, when executed by a processor, causes the method according to any one of (25) to (48) to be performed.

1. Circuitry, configured to:
obtain input video data and associated metadata,
wherein the input video data represent a video sequence, and
wherein the metadata indicate a consistency constraint for modifying a feature of the video sequence;
cause a generative artificial intelligence model to generate a modification of the feature in accordance with the consistency constraint; and
generate output video data that represent the video sequence in which the feature is replaced by the modification of the feature.

2. The circuitry of claim 1,
wherein the consistency constraint indicates a criterion for the modification of the feature for maintaining a consistency of the modification with the video sequence.

3. The circuitry of claim 1,
wherein the consistency constraint indicates at least one of a lighting condition of the feature, a relation between the feature and another feature of the video sequence, and an identity of the feature with another feature of the video sequence.

4. The circuitry of claim 1,
wherein the feature includes movable portions; and
wherein the consistency constraint indicates a position of the movable portions in the video sequence.

5. The circuitry of claim 1,
wherein the feature includes a representation of a drive actor; and
wherein the metadata include a position marker in the representation of the drive actor.

6. The circuitry of claim 1,
wherein the feature includes a character of the video sequence; and
wherein the modification of the feature includes a predetermined appearance of the character.

7. The circuitry of claim 6,
wherein the predetermined appearance includes at least one of a skin color, an ethnicity, a gender, a body type, an age, an outfit, a culture, a religion, and a sexual orientation.

8. The circuitry of claim 6,
wherein the generating of the modification of the feature includes generating a facial expression of the modification corresponding to a facial expression of the character.

9. The circuitry of claim 1,
wherein the generating of the modification of the feature is based on an image provided by a user.

10. The circuitry of claim 1,
wherein the modification of the feature includes a representation of a predetermined accessory.

11. The circuitry of claim 1,
wherein the modification of the feature includes a different amount of explicit content than the feature.

12. The circuitry of claim 1,
wherein the input video data are associated with audio data; and
wherein the circuitry is further configured to cause the generative artificial intelligence model to modify the audio data in accordance with the modification of the feature.

13. The circuitry of claim 12,
wherein the modifying of the audio data includes replacing a voice represented by the audio data with a voice that corresponds to an audio sample provided by a user.

14. The circuitry of claim 1,
wherein the generative artificial intelligence model includes a plurality of portions for generating different aspects of the modification of the feature.

15. A method, comprising:
obtaining input video data and associated metadata,
wherein the input video data represent a video sequence, and
wherein the metadata indicate a consistency constraint for modifying a feature of the video sequence;
causing a generative artificial intelligence model to generate a modification of the feature in accordance with the consistency constraint; and
generating output video data that represent the video sequence in which the feature is replaced by the modification of the feature.

16. The method of claim 15,
wherein the consistency constraint indicates a criterion for the modification of the feature for maintaining a consistency of the modification with the video sequence.

17. The method of claim 15,
wherein the consistency constraint indicates at least one of a lighting condition of the feature, a relation between the feature and another feature of the video sequence, and an identity of the feature with another feature of the video sequence.

18. The method of claim 15,
wherein the feature includes movable portions; and
wherein the consistency constraint indicates a position of the movable portions in the video sequence.

19. The method of claim 15, wherein the feature includes a representation of a drive actor; and
wherein the metadata include a position marker in the representation of the drive actor.

20. A system, comprising:
circuitry configured to:
obtain input video data and associated metadata,
wherein the input video data represent a video sequence, and
wherein the metadata indicate a consistency constraint for modifying a feature of the video sequence;
cause a generative artificial intelligence model to generate a modification of the feature in accordance with the consistency constraint; and
generate output video data that represent the video sequence in which the feature is replaced by the modification of the feature; and
a streaming server configured to:
indicate, to a user, a predetermined set of modifications of the feature;
receive, from the user, a request for a selected modification of the set of modifications;
obtain, from the circuitry, the output video data, wherein the output video data represent the video sequence in which the feature is replaced by the selected modification; and
stream the output video data to the user.
